(19) United States
(12) Patent Application Publication
(10) Pub. No.: US 2009/0246590 A1
(43) Pub. Date: Oct. 1, 2009

(54) FUEL CELL SYSTEM

(75) Inventors: Takuya HONGO, Tokyo (JP); Akihiko ONO, Tokyo (JP); Koichiro KAWANO, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/414,087

(22) Filed: Mar. 30, 2009

(30) Foreign Application Priority Data
Mar. 31, 2008 (JP) P2008-092899

(51) Int. Cl. H01M 8/10

(52) U.S. Cl. 429/30

(57) ABSTRACT

A fuel cell system includes a membrane electrode assembly including an anode electrode, a cathode electrode opposed to the anode electrode, and an electrolyte membrane interposed between the anode electrode and the cathode electrode; a porous body in contact with the anode electrode; an anode passage plate in contact with the porous body, including a gas passage collecting a gas generated in the anode electrode and a fuel passage supplying a fuel to the anode electrode; a first seal portion sealing outer circumferences of the cathode electrode; and a second seal portion sealing outer circumferences of the anode electrode and made of a material having lower CO₂ gas permeability than the first seal portion; and a third seal portion sealing the gas passage and made of a material having lower CO₂ gas permeability than that of the first seal portion.

### CROSS REFERENCE TO RELATED APPLICATIONS AND INCORPORATION BY REFERENCE

This application is based upon and claims the benefit of priority from the prior Japanese Patent Application No. P2008-092899, filed on Mar. 31, 2008; the entire contents of which are incorporated herein by reference.

### BACKGROUND OF THE INVENTION

1. Field of the Invention

The present invention relates to a fuel cell system in which liquid fuel is introduced directly to electrodes.

2. Description of the Related Art

A direct fuel cell that directly supplies liquid fuel such as alcohol to a power generation unit does not require auxiliaries such as a vaporizer and a reformer. Accordingly, it is expected that the direct fuel cell will be used for a compact power supply of a portable instrument.

For example, a direct methanol fuel cell (DMFC) includes a cell stack (electromotive unit) in which a plurality of single cells are stacked on one another. Each of the single cells has an anode and a cathode. Circumferences of each anode and each cathode are individually sealed by seal members. For example, the seal members may be made of silicon rubber having high gas permeability.

In the cell stack, methanol is supplied to the anode, and air is supplied to the cathode, whereby a chemical reaction is caused between the methanol and the air, and electric power is generated from the reaction. Unreacted methanol and CO₂ are discharged from the anode, and water is discharged from the cathode.

As a method for discharging the unreacted methanol and CO₂ from the anode, a method is known, in which methanol and CO₂ are mixed with each other in an anode passage plate, and a formed mixture is discharged as a gas-liquid two-phase flow from an anode outlet. In order to reuse the unreacted methanol, a gas-liquid separator or the like may be provided in a passage on the anode outlet, the gas-liquid two-phase flow is separated into the gas and the liquid thereby, and the gas thus separated is emitted to the atmosphere (for example, refer to U.S. Pat. No. 6,924,055).

However, by the fact that the gas-liquid two-phase flow is flown through the anode passage and the passage on the anode outlet, a pressure loss in the anode passage is sometimes increased. By the fact that the gas-liquid separator is disposed, a circulation unit on the anode is enlarged, and accordingly, it sometimes becomes difficult to miniaturize the DMFC.

As a method for miniaturizing the direct fuel cell by not allowing the gas-liquid two-phase flow to flow through the anode passage and the passage on the anode outlet, a method has been studied, in which a fuel supply passage and a gas passage are provided in combination in the anode passage plate, and a hydrophobic porous body is disposed therein so as to be adjacent to a diffusion layer of an anode electrode. In such a way, while the fuel is prevented from being mixed into the gas passage by using hydrophobic property of the hydrophobic porous body, CO₂ can be selectively collected to the gas passage through the hydrophobic porous body. As a result, the fuel and the gas can be easily separated from each other in the electromotive unit, and the direct fuel cell can be miniaturized, and in addition, the pressure loss on the anode can be reduced.

However, in the above-described example of separating the gas and the liquid from each other by disposing the hydrophobic porous body in the electromotive unit, in the case where the power generation is stopped, inner pressures of the gas passage and the anode are decreased by the fact that the discharge of CO₂ is stopped. Accordingly, CO₂ in a gas collection unit sometimes runs back to the hydrophobic porous body. In the case where liquid droplets are attached into the gas passage and onto an outlet end thereof when the power generation is stopped, the liquid droplets run back toward the hydrophobic porous body while filling the gas passage, and sometimes wet the hydrophobic porous body.

### SUMMARY OF THE INVENTION

An aspect of the present invention inheres in a fuel cell system encompassing a membrane electrode assembly including an anode electrode, a cathode electrode, and an electrolyte membrane interposed between the anode electrode and the cathode electrode; a porous body in contact with the anode electrode; an anode passage plate in contact with the porous body, including a gas passage collecting a gas generated in the anode electrode and a fuel passage supplying a fuel to the anode electrode; a first seal portion sealing outer circumferences of the cathode electrode; and a second seal portion sealing outer circumferences of the anode electrode; and a third seal portion sealing the gas passage, wherein the second seal portion and the third seal portion include a material including lower CO₂ gas permeability than the first seal portion.

Another aspect of the present invention inheres in a fuel cell system encompassing a fuel container containing a fuel; a fuel cell connected to the fuel container, including: a membrane electrode assembly including an anode electrode, a cathode electrode, and an electrolyte membrane interposed between the anode electrode and the cathode electrode; a porous body in contact with the anode electrode; an anode passage plate in contact with the porous body, including a gas passage collecting a gas generated in the anode electrode and a fuel passage supplying the fuel to the anode electrode; a first seal portion sealing outer circumferences of the cathode electrode; and a second seal portion sealing outer circumferences of the anode electrode; and a third seal portion sealing the gas passage, wherein the second seal portion and the third seal portion include a material including lower CO₂ gas permeability than the first seal portion; and a circulation line connected to the fuel passage, configured to circulate the fuel discharged from an outlet of the fuel passage to an inlet of the fuel passage.

### BRIEF DESCRIPTION OF DRAWINGS

FIG. 1 is a schematic diagram illustrating a fuel cell according to a first embodiment and is viewed from a direction A-A of FIGS. 2A to 2E;

FIG. 2A is a plan view illustrating a second anode passage plate according to the first embodiment;

FIG. 2B is a plan view illustrating a seal portion interposed between a first anode passage plate and the second anode passage plate according to the first embodiment;

FIG. 2C is a plan view illustrating the first anode passage plate according to the first embodiment;

FIG. 2D is a plan view illustrating a seal portion which seals peripheral edge portions of an anode electrode according to the first embodiment;

FIG. 2E is a plan view illustrating a hydrophobic porous body according to the first embodiment;

FIG. 3 is a schematic diagram illustrating flows of fuel and discharged gas at the time when a fuel cell generates power;

FIG. 4 is a schematic diagram illustrating flows of fuel and discharged gas at the time when a fuel cell stops power generation;

FIG. 5 is a table showing gas permeabilities of a variety of rubber materials in the case where gas permeability of natural rubber at 25° C. is set at 100;

FIG. 6 is a graph showing results of measuring gas absorption amounts of a hydrophobic porous body according to the first embodiment;

FIG. 7 is a table showing measurement results of gas permeabilities of variety of rubber materials in accordance with JIS K-7126 method;

FIG. 8 is a schematic diagram illustrating a fuel cell according to a first modification;

FIG. 9 is a schematic diagram illustrating a fuel cell according to a second modification;

FIG. 10 is a schematic diagram illustrating a fuel cell according to a third modification;

FIG. 11 is a schematic diagram illustrating a fuel cell according to a fourth modification;

FIG. 12 is a schematic diagram illustrating a fuel cell according to a fifth modification and is viewed from a direction B-B of FIG. 2C;

FIG. 13 is a schematic diagram illustrating a fuel cell according to a sixth modification and is viewed from a direction C-C of FIGS. 14A to 14E;

FIG. 14A is a plan view illustrating a second anode passage plate in FIG. 13;

FIG. 14B is a plan view illustrating a seal portion interposed between a first anode passage plate and the second anode passage plate in FIG. 13;

FIG. 14C is a plan view illustrating the first anode passage plate in FIG. 13;

FIG. 14D is a plan view illustrating a seal portion which seals peripheral edge portions of an anode electrode in FIG. 13;

FIG. 14E is a plan view illustrating a hydrophilic porous body in FIG. 13;

FIG. 15 is a schematic diagram illustrating a fuel cell according to a second embodiment and is viewed from a direction D-D of FIGS. 16A to 16E;

FIG. 16A is a plan view illustrating a second anode passage plate in FIG. 15;

FIG. 16B is a plan view illustrating a seal portion interposed between a first anode passage plate and the second anode passage plate in FIG. 15;

FIG. 16C is a plan view illustrating the first anode passage plate in FIG. 15;

FIG. 16D is a plan view illustrating a seal portion which seals peripheral edge portions of an anode electrode in FIG. 15;

FIG. 16E is a plan view illustrating a hydrophobic porous body in FIG. 15; and

FIG. 17 is a graph showing results of gas adsorption amounts of hydrophobic porous body of the present embodiment and the comparative example.

### DETAILED DESCRIPTION OF THE EMBODIMENT OF THE INVENTION

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified. In the following descriptions, numerous details are set forth such as specific signal values, etc. to provide a thorough understanding of the present invention. However, it will be obvious to those skilled in the art that the present invention may be practiced without such specific details.

### FIRST EMBODIMENT

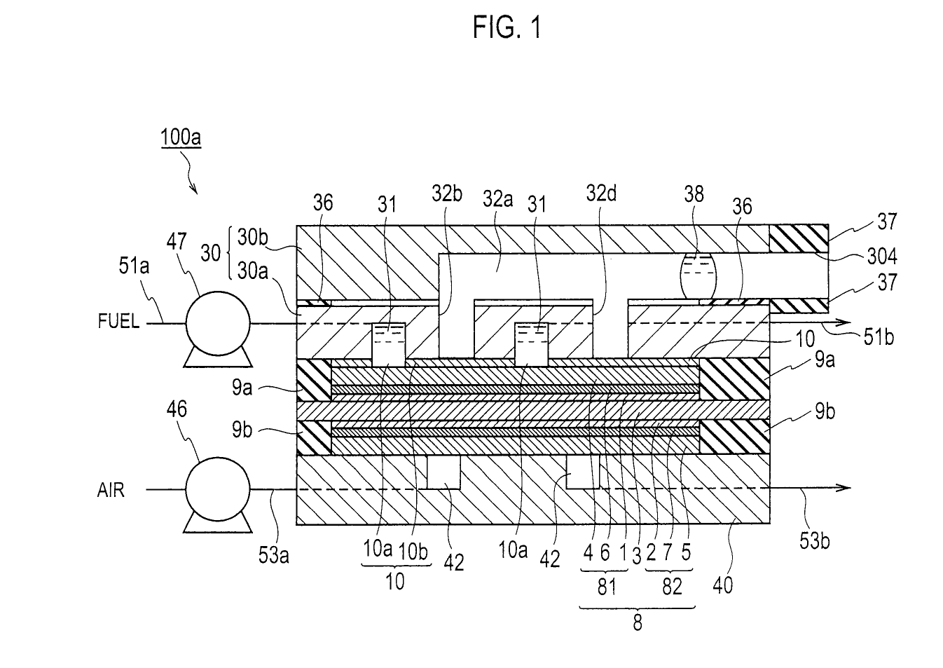

As shown in FIG. 1, the fuel cell 100a (fuel cell system) includes: a membrane electrode assembly (MEA) 8 having an anode electrode 81 and a cathode electrode 82, which are opposite to each other while sandwiching an electrolyte membrane 3 therebetween; a hydrophobic porous body 10 in contact with the MEA 8; an anode passage plate 30 in contact with the hydrophobic porous body 10; and a cathode passage plate 40 opposite to the anode passage plate 30 while interposing the MEA 8 therebetween.

The MEA 8 includes: the electrolyte membrane 3; an anode catalyst layer 1 and a cathode catalyst layer 2, which are formed by applying a catalyst; and an anode gas diffusion layer 4 and a cathode gas diffusion layer 5, which are formed on an outside of the anode catalyst layer 1 and an outside of the cathode catalyst layer 2, respectively.

The electrolyte membrane 3 may be composed of the proton-conductive polymer electrolyte membrane and the like. Platinum-Ruthenium (Pt—Ru) binary alloy and the like can be used as the anode catalyst layer 1, and platinum and the like can be used as the cathode catalyst layer 2. Porous carbon paper and the like can be used as the anode gas diffusion layer 4 and the cathode gas diffusion layer 5.

Between the anode catalyst layer 1 and the anode gas diffusion layer 4, a carbon-made anode microporous layer 6 with a thickness of several ten microns, which has micropores with a submicron pore diameter and is subjected to hydrophobic treatment, may be disposed. Note that the “hydrophobic treatment” refers to treatment for increasing a contact angle between such a porous body and water more than 90°. Between the cathode catalyst layer 2 and the cathode gas diffusion layer 5, a carbon-made cathode microporous layer 7 with a thickness of several ten microns, which has micropores with a submicron pore diameter, may be disposed.

As the hydrophobic porous body 10, carbon paper can be used, which is formed of carbon fiber subjected to the hydrophobic treatment and has micropores with a pore diameter of several microns. Here, the carbon paper has a thickness of approximately 200 μm. Besides the carbon paper, there can be used a material formed by implementing hydrophobic treatment for sintered metal, and a material having hydrophobicity (that is, a hydrophobic material), which is an electric conductive porous body having micropores with a pore diameter of several microns or less. Note that the “hydrophobicity” stands for property that a contact angle between a material concerned and water is larger than 90°. By disposing the hydrophobic porous body 10, Co₂ and the fuel can be easily subjected to the gas-liquid separation even if the MEA 8 is inclined in an arbitrary direction.

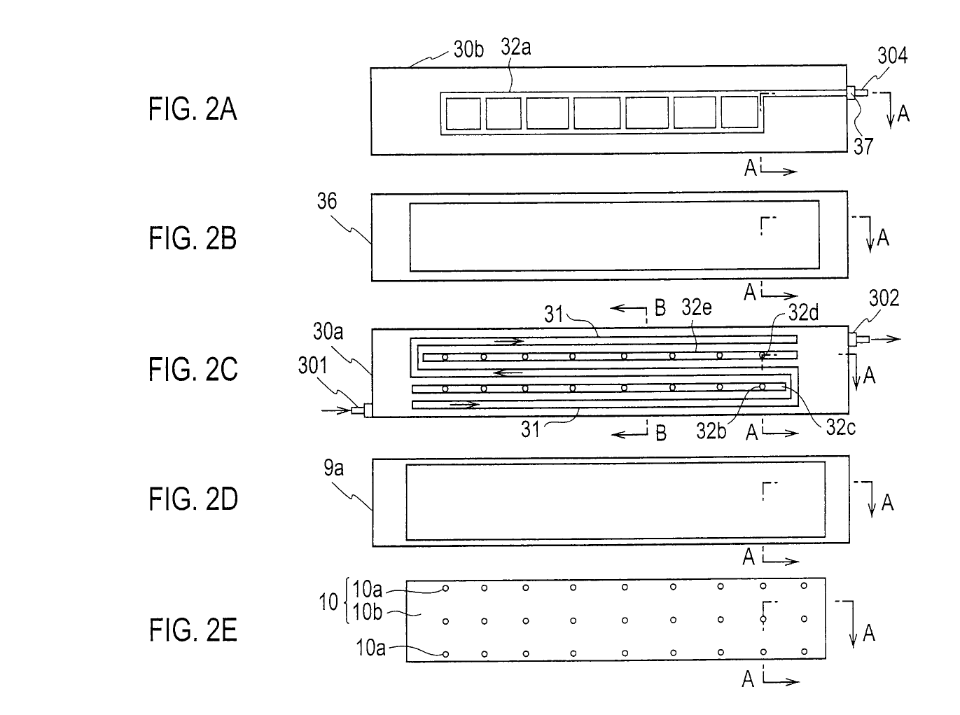

It is preferable that the hydrophobic porous body 10 have a plurality of through holes 10a which penetrate a surface thereof in contact with the anode gas diffusion layer 4 and a surface thereof in contact with the anode passage plate 30. For example, as shown in FIG. 2E, the through holes 10a are opened in a grid pattern on the surface of the hydrophobic carbon porous body having the micropores with a pore diameter of several microns. A pore diameter of the through holes 10a can be made sufficiently larger than the several microns which are the pore diameter of the micropores composing the hydrophobic porous body 10. For example, the pore diameter of the through holes 10a can be set at, for example, approximately 1 mm. Moreover, the pore diameter of the through holes 10a is appropriately changeable in response to a width and the like of a passage of the anode passage plate 30.

The through holes 10a are arranged to be opposite to a region where a fuel passage 31 is disposed. The through holes 10a are arranged so as to be directly connected to the fuel passage 31. A shape of the through holes 10a is not particularly limited. For example, the through holes 10a may be formed along a serpentine shape of the fuel passage 31, which is shown in FIG. 2C. Alternatively, the through holes 10a do not have to be provided.

Peripheral edge portions of the cathode catalyst layer 2, the cathode microporous layer 7 and the cathode gas diffusion layer 5 are sealed by a first seal portion 9b. The first seal portion 9b has a form cut out in a frame shape along outer circumferences of the cathode catalyst layer 2, the cathode microporous layer 7 and the cathode gas diffusion layer 5. Peripheral edge portions of the anode catalyst layer 1, the anode microporous layer 6 and the anode gas diffusion layer 4 are sealed by a second seal portion 9a as shown in FIG. 2D. The second seal portion 9a is formed into a frame shape along outer circumferences of the anode catalyst layer 1, the anode microporous layer 6 and the anode gas diffusion layer 4.

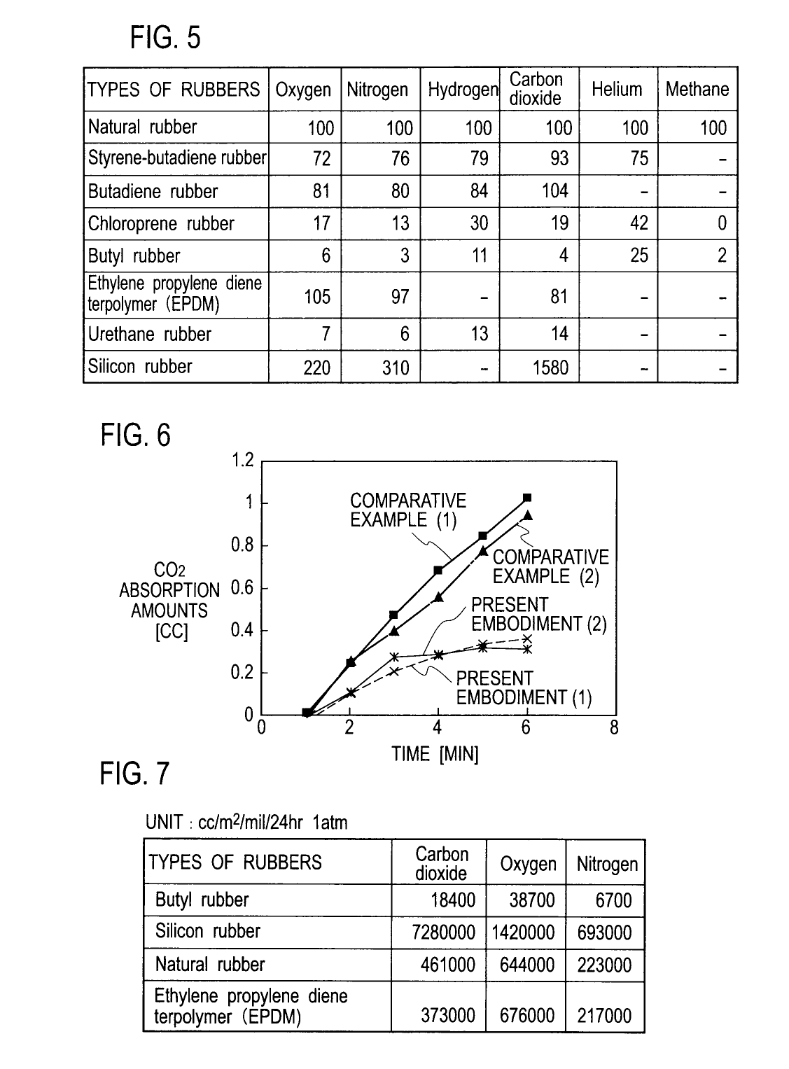

As a material of the first seal portion 9b, silicon rubber (silicon resin-made rubber) having relatively high gas permeability is suitable. As a material of the second seal portion 9a, a material having lower CO₂ gas permeability than the material of the first seal portion 9b is suitable. FIG. 5 shows examples of gas permeabilities of a variety of rubber materials in the case where gas permeability of natural rubber at 25° C. is set at 100. As such rubber materials, there are styrene-butadiene rubber, butadiene rubber, chloroprene rubber, butyl rubber, ethylene propylene diene terpolymer (EPDM), urethane rubber, or the like. All of the materials other than the silicon rubber, which are shown in FIG. 5, are significantly inferior in CO₂ permeability to the silicon rubber.

As a material of the second seal portion 9a, the EPDM is preferably used. As such a material, the EPDM has property to be less likely to allow permeation of hydrogen while has property to allow permeation of oxygen and nitrogen, and has durability under high-temperature/high-pressure conditions. Accordingly, the EPDM is suitable. Besides the EPDM, polyphenylene sulfide (PPS) resin, polyether ether ketone (PEEK) resin and the like can also be suitably used as the material of the second seal portion 9a since these materials have such high-temperature/high-pressure durabilities and have properties to be less likely to allow the permeation of the hydrogen and permeation of CO₂.

As shown in FIG. 1, the anode passage plate 30 includes a first anode passage plate 30a and a second anode passage plate 30b; however, the anode passage plate 30 may have a structure in which both thereof are integrated with each other. As shown in FIG. 2C, the first anode passage plate 30a includes the fuel passage 31 and gas passages 32c and 32e, which are formed into a groove shape on a surface thereof in contact with the hydrophobic porous body 10. In the gas passages 32c and 32e, there are formed gas passages 32b and 32d which penetrate both surfaces of the first anode passage plate 30a.

For the fuel passage 31, for example, a serpentine passage that meanders sending the fuel from an upstream side to a downstream side (toward a direction of an arrow in FIG. 1) can be employed. However, the fuel passage 31 may be formed into parallel passages in which a plurality of passages are connected to one another. As shown in FIG. 2C, the upstream side of the fuel passage 31 is connected to a fuel supply port 301, and the downstream side thereof is connected to a fuel discharge port 302. An upstream side of the fuel supply port 301 is connected to a fuel supply line 51a of FIG. 1 through a manifold and the like. On the fuel supply line 51a, a fuel pump 47 is provided. By the fuel pump 47, a predetermined amount of the fuel is supplied into the fuel passage 31. A downstream side of the fuel discharge port 302 is connected to a fuel discharge line 51b of FIG. 1 through a manifold and the like.

As shown in FIG. 2A, on a surface of the second anode passage plate 30b, a groove-like gas passage 32a connected to the gas passages 32b and 32d is disposed. A shape of the gas passage 32a is not limited to that in FIG. 2A. A circumference of an outlet end 304 of the gas passage 32a is sealed by a seal portion 37 (third seal portion). As a material of the seal portion 37, a material having lower CO₂ gas permeability than the material of the first seal portion 9b is suitable. Specifically, the EPDM and the like are suitable as the material of the seal portion 37.

As shown in FIG. 2B, between the first anode passage plate 30a and the second anode passage plate 30b, a seal portion 36 for preventing an outflow of the gas collected through the gas passages 32b and 32d is disposed. As a material of the seal portion 36, a material having lower CO₂ gas permeability than the material of the first seal portion 9b is suitable. Specifically, the EPDM and the like are suitable as the material of the seal portion 36.

As shown in FIG. 1, the cathode passage plate 40 is in contact with the cathode gas diffusion layer 5, and includes an air introduction passage 42 for feeding the air to the cathode catalyst layer 2. An inlet side of the air introduction passage 42 is connected to an air supply line 53a, and the air is introduced thereinto through an air pump 46. An outlet side of the air introduction passage 42 is connected to an air discharge line 53b through a manifold and the like. The air to be introduced into the air introduction passage 42 may be captured from an outside of the fuel cell 100a through the air pump 46. Alternatively, for the above-described air, the gas collected in the gas passages 32a to 32e may be reused. The air may be introduced by natural aspiration (breathing) without using the air pump 46. The cathode passage plate 40 may be omitted.

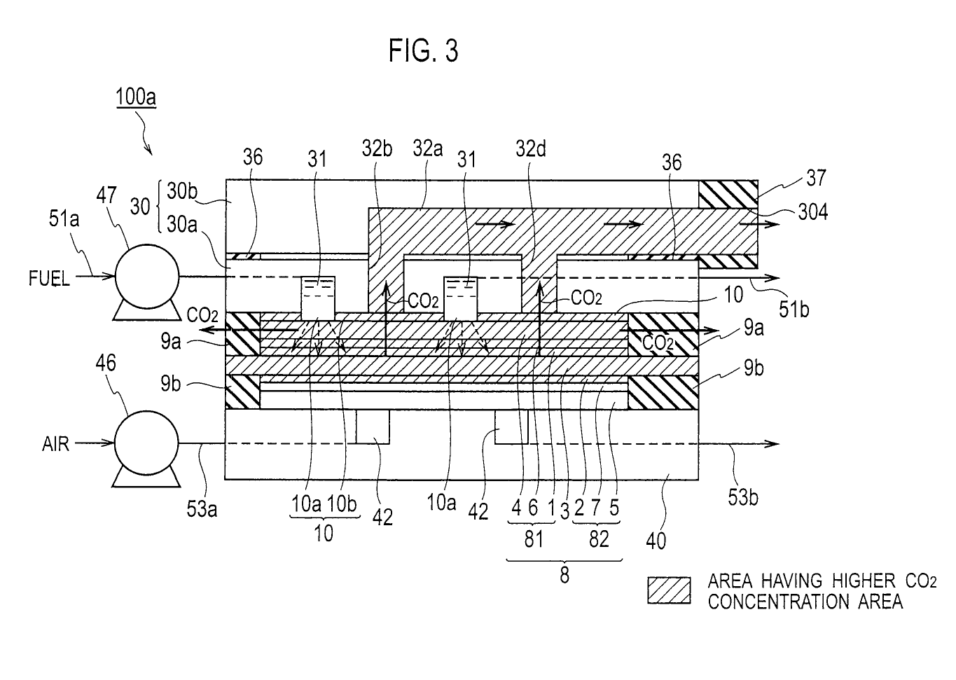

FIG. 3 shows a conceptual diagram of the flows of the fuel and discharged gas (CO₂) at the time when the fuel cell 100a according to the first embodiment generates power.

At the time of such power generation, the fuel pump 47 is driven, whereby the fuel is supplied from the fuel supply line 51a to the fuel passage 31. Moreover, the air pump 46 is driven, whereby the air is supplied from the air supply line 53a to the air introduction passage 42. Since the hydrophobic porous body 10 is hydrophobic, the fuel fed to the fuel passage 31 directly passes through the through holes 10a without permeating the hydrophobic porous body 10, and as shown by directions of dotted arrows, is sent to the anode electrode 81 side.

On the anode electrode 81 side, CO₂ is generated by the anode reaction. Here, on an interface between the anode gas diffusion layer 4 and the hydrophobic porous body 10, it is easier for CO₂ to pass through the inside of the hydrophobic porous body 10 having the micropores than to enter the liquid (fuel) filled in the through holes 10a and to thereby form bubbles. Accordingly, CO₂ passes through the inside of the hydrophobic porous body 10 while giving a higher priority thereto.

As shown by solid arrows of FIG. 3, CO₂ that has passed through the inside of the hydrophobic porous body 10 is collected through the gas passages 32a to 32e connected to the hydrophobic porous body 10. As a result, CO₂ can be suppressed from flowing to the fuel passage 31 side. Accordingly, the gas hardly flows into the fuel passage 31. Therefore, a flow rate increase owing to volume expansion caused by the fact that a gas-liquid two-phase flow is formed in the inside of the fuel passage 31 is suppressed. Moreover, a fluid pressure loss owing to formation of a meniscus, which is caused by the same fact, is suppressed. Hence, a pressure loss in the anode (fuel passage 31) can be greatly reduced.

Here, for example, a case is assumed where the silicon rubber is used as the first and second seal portions 9a and 9b. The CO₂ gas permeability of the silicon rubber exhibits a value four times or more those of N₂ gas and O₂ gas, which are contained in the air (for example, refer to FIG. 7).

At the time of the power generation, in the cathode catalyst layer 2, the electrolyte membrane 3, the anode catalyst layer 1, the anode gas diffusion layer 4, the anode microporous layer 6 and the gas passages 32a to 32e, the CO₂ gas particularly increases a concentration thereof, and concentrations of the O₂ gas and the N₂ gas become substantially zero. Meanwhile, though a concentration of the CO₂ gas in the atmosphere is as low as approximately 0.04%, concentrations of the O₂ gas and the N₂ gas are approximately 22% and approximately 78%, respectively.

As described above, each of the gases has a concentration difference between the inside and outside of the fuel cell 100a. Accordingly, a diffusion of the CO₂ gas occurs from the inside of the fuel cell 100a to the outside thereof through the second seal portion 9a. In a similar way, diffusions of the O₂ gas and the N₂ gas occur from the outside of the fuel cell 100a to the inside thereof through the second seal portion 9a.

However, the CO₂ gas permeability of the silicon rubber is four times or more those of the N₂ gas and the O₂ gas. Moreover, the concentration difference of the CO₂ gas between the inside and outside of the fuel cell 100a is substantially equal to that of the N₂ gas therebetween. Accordingly, a diffusion amount of the CO₂ gas becomes larger than diffusion amounts of the N₂ gas and the O₂ gas. As a result, in the case of using the silicon rubber as the second seal portion 9a, the CO₂ gas is continuously discharged to the outside of the fuel cell 100a through the second seal portion 9a. For example, in the case where 2.5 ccm to 2.8 ccm of CO₂ is generated from the anode catalyst layer 1 at the time when the fuel cell 100a generates power, approximately 0.3 ccm of the gas (CO₂) comes out of the fuel cell 10a through the second seal portion 9a. Note that “ccm” represents mL/min. at the time when such a volume of the gas is converted into a value at 25° C. under 1 atm.

When the power generation is stopped, the generation of CO₂ from the anode catalyst layer 1 is stopped. Then, inner pressures of the anode electrode 81 (anode catalyst layer 1, anode microporous layer 6, anode gas diffusion layer 4) and the gas passages 32a to 32e are decreased, and the gas flows in a direction from the outlets of the gas passages to the hydrophobic porous body 10. This direction is reverse to the flowing direction at the time of the power generation.

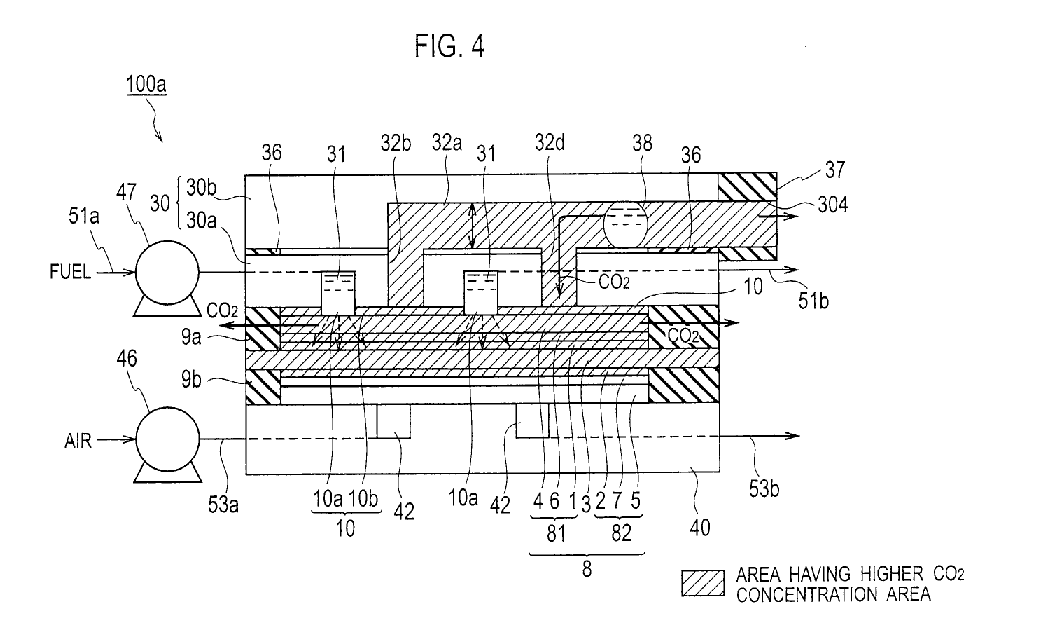

As a result, as shown in FIG. 4, following the flow of CO₂, liquid droplets 38 attached onto the gas passages 32a to 32e and the outlet end 304 thereof flow in a direction of the hydrophobic porous body 10. Note that the liquid droplets 38 refer to condensed water of steam, and sometimes refer to fuel leaked owing to a failure of the gas-liquid separation. In the case where the liquid droplets 38 move so easily as not to hinder the flow of CO₂, the liquid droplets 38 directly reach the hydrophobic porous body 10, and accordingly, sometimes wet the hydrophobic porous body 10. Meanwhile, even if the liquid droplets 38 do not move, the inner pressures of the gas passages 32a to 32e and the anode electrode 81 (anode catalyst layer 1, anode microporous layer 6, anode gas diffusion layer 4) are decreased to an extent where the fuel in the fuel passage 31 overcomes the hydrophobicity of the hydrophobic porous body 10 and is absorbed thereto. This causes the hydrophobic porous body 10 to be wet by the liquid.

When the liquid occupies the hydrophobic porous body 10 between the fuel passage 31 and the gas passages 32a to 32e, a state appears where the fuel easily flows from the fuel passage 31 to the gas passages 32a to 32e through the inside of the hydrophobic porous body 10. Accordingly, it becomes difficult to maintain the gas-liquid separation between the fuel and the gas in the inside of the fuel cell 100a. Such an undesirable state may be solved only if the fuel cell 100a is returned to a state of the power generation to generate the CO₂ gas, or only if the hydrophobic porous body is heated to evaporate the liquid therein, whereby a major part of the hydrophobic porous body 10 is filled with the gas.

In the first embodiment, the material such as the EPDM having the lower CO₂ permeability than the silicon rubber is used as the material of the second seal portion 9a and the third seal portions 36 and 37. In such a way, CO₂ can be suppressed from flowing out of the second seal portion 9a and the third seal portions 36 and 37. Accordingly, such a phenomenon as described above that the flow of the gas becomes reverse when the power generation is stopped can be suppressed. This is because the CO₂ gas permeability of the EPDM is substantially equal to the N₂ and O₂ gas permeabilities thereof in addition to that the CO₂ permeability of the EPDM is smaller than that of the silicon rubber. Since the EPDM is excellent in solvent resistance, the EPDM is suitable as a sealing material of the fuel cell 100a if it is noted that the EPDM is somewhat inferior to the silicon rubber in heat durability and cold durability.

Note that, though the EPDM is mentioned here as the effective material for the fuel cell 100a according to the first embodiment, other materials may be used as long as they have material properties suitable for sealing the fuel cell, for example, such as the heat resistance, the cold resistance and the solvent resistance, and have structures to function as the sealing material of the fuel cell. For example, materials other than the rubber, in each of which the CO₂ gas permeability is lower than that of the silicon rubber, for example, PEEK, PPS or the like can be used. Moreover, if these materials are coated on the surfaces of the silicon rubber seals, which are located outside of the fuel cell and exposed to the atmosphere, then a similar effect to that in the case of using the EPDM as the seals can be obtained.

FIG. 6 shows results of measuring CO₂ absorption amounts of the hydrophobic porous body 10 by using the fuel cell 100a according to the first embodiment. “PRESENT EMBODIMENT (1)” is a result showing a CO₂ absorption amount of the hydrophobic porous body 10 with respect to an elapsed time since the operation of the fuel cell 100a was stopped. In the “PRESENT EMBODIMENT (1)”, the fuel cell 100a uses the EPDM as the second and third seal portions 9a, 36 and 37, and was operated for 3 minutes before starting to measure the elapsed time. “PRESENT EMBODIMENT (2)” is a result showing a CO₂ absorption amount of the hydrophobic porous body 10 with respect to the elapsed time since the operation of the fuel cell 100a was stopped. In the “PRESENT EMBODIMENT (2)”, the fuel cell 100a was operated for 1 hour before starting to measure the elapsed time. “COMPARATIVE EXAMPLE (1)” is a result showing a CO₂ absorption amount of the hydrophobic porous body 10 with respect to the elapsed time since the operation of the fuel cell 100a was stopped. In the “COMPARATIVE EXAMPLE (1)”, the fuel cell 100a uses the silicon rubber as the second and third seal portions 9a, 36 and 37, and was operated for 3 minutes before starting to measure the elapsed time. “COMPARATIVE EXAMPLE (2)” is a result showing a CO₂ absorption amount of the hydrophobic porous body 10 with respect to the elapsed time since the operation of the fuel cell 100a was stopped. In the “COMPARATIVE EXAMPLE (2)”, the fuel cell 100a was operated for 1 hour before starting to measure the elapsed time.

In accordance with the present embodiment, the CO₂ absorption amount can be suppressed to one-third of that in the comparative examples. Accordingly, it is understood that a radical pressure change on the anode side is suppressed at the time when the operation of the fuel cell is stopped, whereby the reverse flow of the CO₂ gas from the gas passages 32a to 32e can be suppressed effectively.

Note that the configurations and arrangements of the fuel passage 31 and the gas passages 32a to 32e, which are shown in FIG. 1 and FIGS. 2A to 2E, are merely examples, and it is a matter of course that other various configurations are adoptable. In the first embodiment, the description has been made of the example of the fuel cell 100a that utilizes the liquid such as a methanol solution; however, the liquid may be alcohol, a hydrocarbon solution, ether or the like besides the methanol.

### (First Modification)

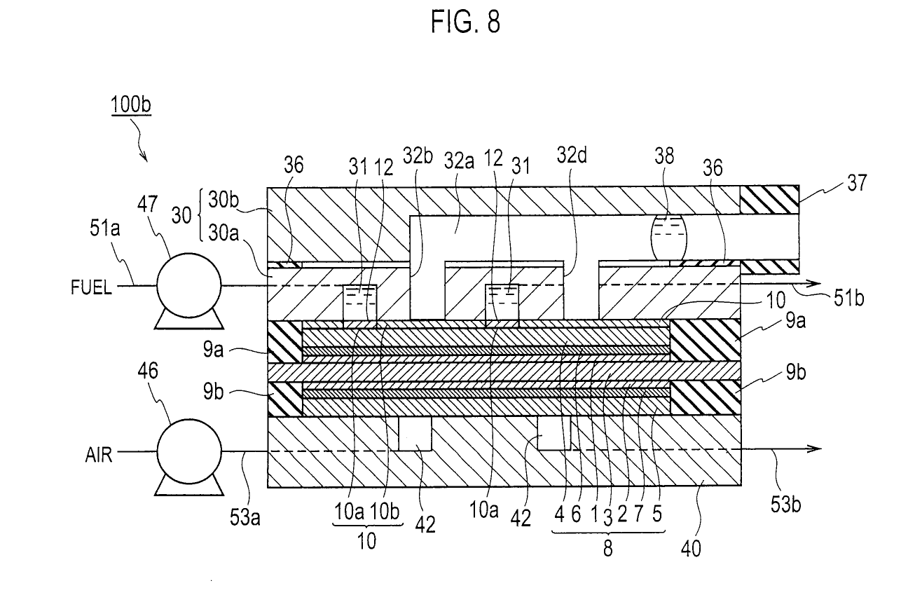

As shown in FIG. 8, in a fuel cell 100b (fuel cell system) according to a first modification of the first embodiment, hydrophilic porous bodies (that is, porous bodies having hydrophilicity) 12 are embedded in the through holes 10a of the hydrophobic porous body 10. Note that the “hydrophilicity” stands for property that the contact angle between the material concerned and water is smaller than 90°.

As the hydrophilic porous bodies 12, those in which the following materials are molded into a predetermined shape in order to be embedded in the through holes 10a are usable. Specifically, the materials are: carbon paper or carbon cloth, which has micropores with a pore diameter of several microns and is made of carbon fiber subjected to hydrophilic treatment; hydrophilic sintered metal that has micropores with a pore diameter of several microns; a hydrophilic porous material that has micropores with a pore diameter of several microns or less, and has electric conductivity; and the like. Moreover, a hydrophobic material may be used, in which a part is subjected to hydrophilic treatment by being sprayed with a polymer containing a sulfonic acid group. The hydrophilic porous bodies 12 may be embedded in portions of the through holes 10a, which are in contact with the hydrophobic porous bodies 10. Others are substantially similar to those of the fuel cell 100a shown in FIG. 1, and accordingly, a description thereof is omitted.

In accordance with the fuel cell 100b shown in FIG. 8, the hydrophilic porous bodies 12 are arranged in the though holes 10a. Accordingly, the fuel becomes likely to be held in the hydrophilic porous bodies 12, and it becomes possible to separate CO₂ more stably, whereby the fuel cell 100b can be operated more stably.

### (Second Modification)

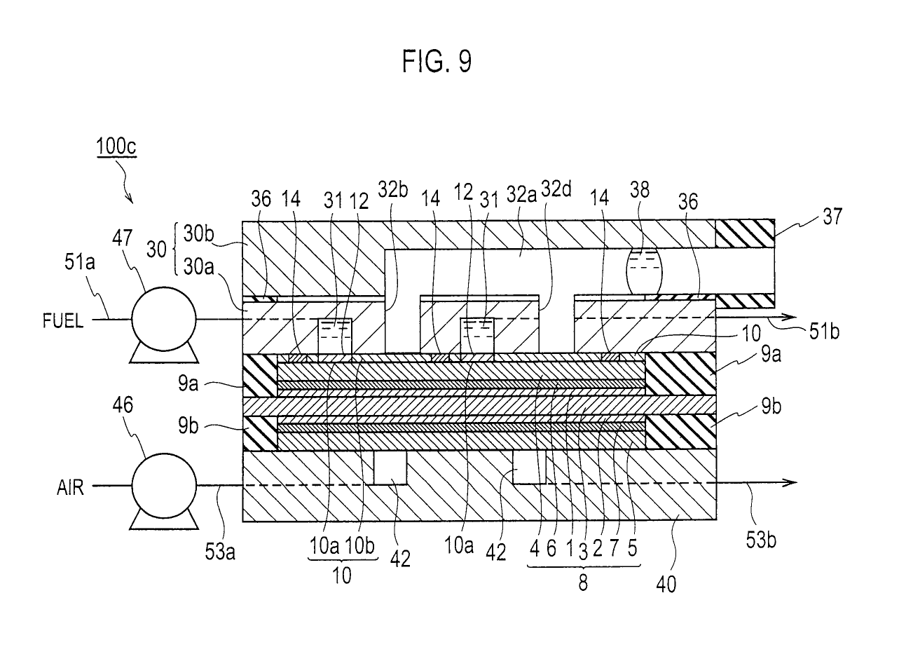

As shown in FIG. 9, in a fuel cell 100c (fuel cell system) according to a second modification of the first embodiment, the hydrophilic porous bodies 12 are embedded in the through holes 10a of the hydrophobic porous body 10. Moreover, contacts 14 which penetrate both surfaces of the hydrophobic porous body 10 are embedded in regions of the hydrophobic porous body 10, which are not in contact with the fuel passage 31 and the gas passages 32b and 32d. The contacts 14 achieve electric conduction of the hydrophobic porous body 10 with the anode gas diffusion layer 4 and the anode passage plate 30.

In the case where the contacts 14 are arranged, a non-conductive material with a pore diameter of several microns or less, such as extended polyfluoroethylene (extended PTFE), is also usable as the hydrophobic porous body 10. In this case, it is preferable that carbon or metal be used as the contacts 14. Moreover, a part of the extended PTFE as the hydrophobic porous body 10 is subjected to the hydrophilic treatment. Alternatively, through holes are opened in the extended PTFE, and are filled with hydrophilic porous bodies made of porous cellulose and the like. In such a way, it is possible to supply the fuel through spaces made as the through holes or through the hydrophilic porous bodies. Other configurations are substantially similar to those of the fuel cell 100a shown in FIG. 1, and accordingly, a description thereof is omitted.

In accordance with the fuel cell 100c shown in FIG. 9, even if the hydrophobic porous body 10 is a nonconductor or is made of a material having so high resistance as to be less likely to allow electric conduction therethrough, the electric conduction can be achieved by the contacts 14. Accordingly, the fuel cell 100c is capable of generating the power satisfactorily.

### (Third Modification)

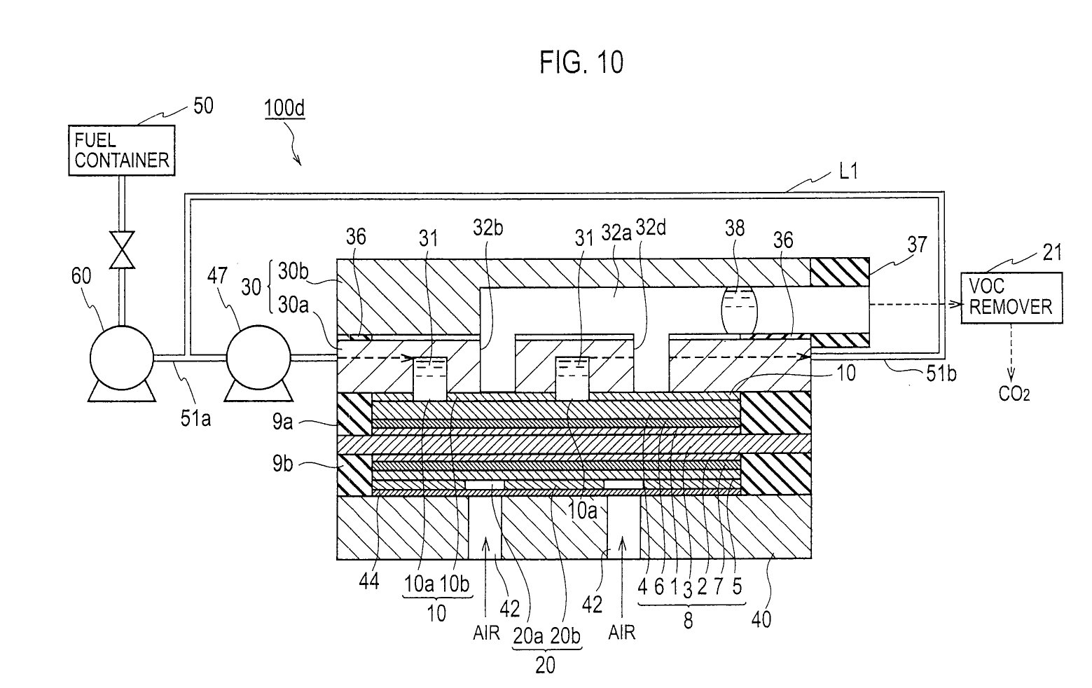

As shown in FIG. 10, in a fuel cell 100d (fuel cell system) according to a third modification of the first embodiment, a circulation line L1 that collects unreacted fuel discharged from an outlet side of the anode passage plate 30 and circulates the unreacted fuel to the fuel passage 31 is connected between the fuel discharge line 51b and the fuel supply line 51a. In the cathode passage plate 40, a chemical filter 44 for adsorbing impurities in the air is disposed. The chemical filter 44 is brought into contact with a porous body 20. The porous body 20 includes a region 20b in contact with the cathode gas diffusion layer 5, and through holes 20a connected to the air introduction passage 42. A pump, a compressor or the like is not connected to the air introduction passage 42, and the air is adapted to be supplied thereto from the outside of the fuel cell 100d by the natural aspiration method. A liquid feed pump 60 is disposed on a downstream side of a fuel container 50 in which high-concentration fuel such as methanol is housed.

Although not shown in FIG. 10, a mixing tank can also be disposed between the liquid feed pump 60 and the fuel pump 47. The mixing tank is a tank for mixing the high-concentration fuel supplied from the fuel container 50 and the liquid supplied from the circulation line L1 with each other, thereby preparing a methanol aqueous solution with a constant concentration. A volatile organic compound (VOC) remover 21 is connected to an outlet side of the gas passage 32a. Other configurations are substantially similar to those of the fuel cell 100a shown in FIG. 1, and accordingly, a description thereof is omitted.

In accordance with the fuel cell 100d shown in FIG. 10, the gas-liquid separation can be performed therein. Accordingly, it becomes unnecessary to dispose the gas-liquid separator on the outlet side of the anode passage plate 30 in the case of reusing the unreacted fuel discharged from the outlet side of the anode passage plate 30, whereby the whole fuel cell system can be miniaturized. Moreover, since the gas is hardly contained in the fluid flowing through the circulation line L1, a pressure loss of the fluid in the circulation line L1 can also be reduced.

### (Fourth Modification)

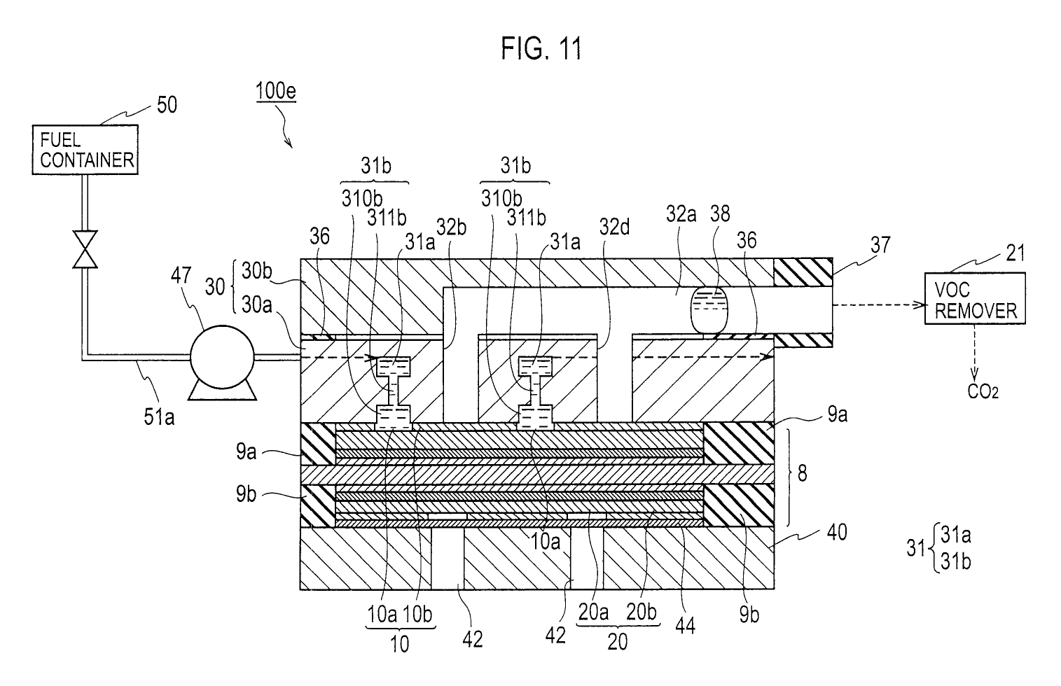

As shown in FIG. 11, a fuel cell 100e (fuel cell system) according to a fourth modification of the first embodiment includes, as the fuel passage 31, a flow portion 31a connected to the fuel supply line 51a, and a feed portion 31b connected to the flow portion 31a. The feed portion 31b includes a first passage 310b in contact with the hydrophobic porous body 10, and a second passage 311b that is connected to the first passage 310b and has larger fluid diffusion resistance than the first passage 310b.

As the second passage 311b, a passage can be used, in which fluid diffusion resistance is increased more than fluid diffusion resistance of the first passage 310b by disposing a pipe thinner in diameter than the first passage 310b for the passage concerned, disposing a plate having micropores therein, and so on.

The fuel stored in the fuel container 50 passes through the fuel supply line 51a and the fuel pump 47, passes through the flow portion 31a, the second passage 311b and the first passage 310b, and thereafter, passes through the through holes 10a of the hydrophobic porous body 10, and flows to the anode gas diffusion layer 4. Meanwhile, CO₂ generated by the anode reaction passes from the anode gas diffusion layer 4 through a region of the hydrophobic porous body 10, in which the through holes 10a are not opened, and is introduced into the VOC remover 21 through the gas passages 32a to 32e. A very small quantity of organic substances contained in CO₂ is removed in the VOC remover 21. Other configurations are substantially similar to those of the fuel cell 100a shown in FIG. 1, and accordingly, a description thereof is omitted.

In accordance with the fuel cell 100e shown in FIG. 11, the fuel is supplied to the first passage 310b through the second passage 311b. Accordingly, a flow rate of the fuel in the second passage 31b is accelerated to an extent of preventing reverse diffusion of the water from the MEA 8 side to the first passage 310b. As a result, the fuel on an upstream side of the second passage 311b is not diluted. Therefore, the fuel cell 100e is capable of generating the power stably. It becomes unnecessary to circulate the fuel in the fuel cell 100e, whereby it becomes possible to miniaturize a fuel circulation unit, and to reduce power for auxiliaries.

### (Fifth Modification)

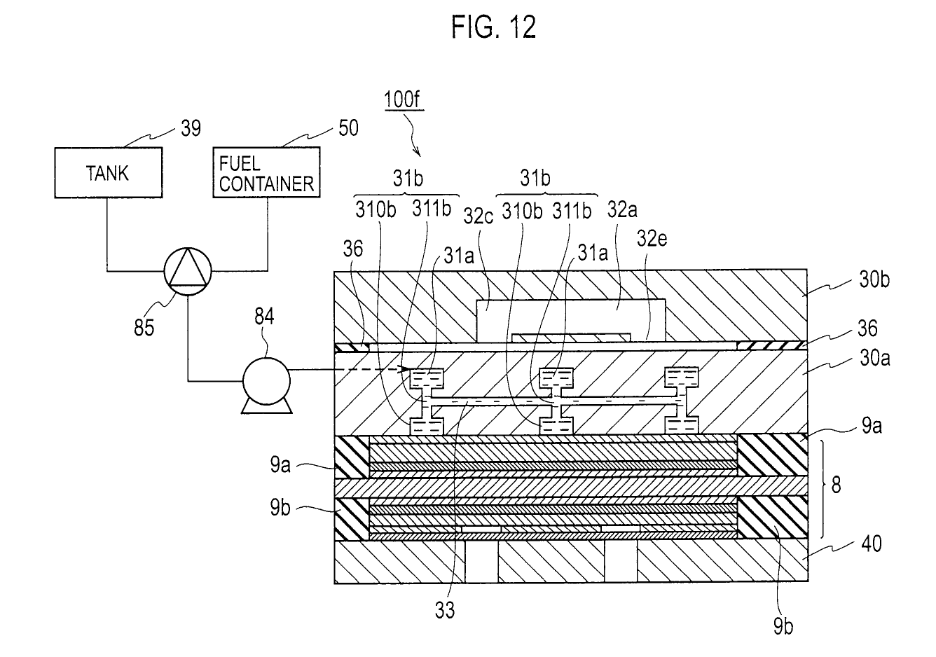

As shown in FIG. 12, a fuel cell system 100f according to a fifth embodiment includes a branch passage 33. The branch passage 33 is connected to individual portions of the first passages 310b, which are connected to the plurality of through holes 10a, through the second passage 311b. The branch passage 33 is connected to a pump 84. The pump 84 feeds the fuel, which is stored in the fuel container 50, to the first passage 310b through the flow portion 31a and the second passage 311b. Alternatively, the pump 84 drains the fuel, which is located in the first passage 310b, to the outside of the fuel cell 100f. An upstream portion of the pump 84 is connected to the fuel container 50 and a tank 39 through a switching valve 85. The tank 39 stores the fuel in the first passage 310b, which is collected through the branch passage 33. Other configurations are substantially similar to those of the fuel cell 100e shown in FIG. 11.

When the configuration of the fuel cell 100f shown in FIG. 12 is adopted, by the fact that the second passage 311b in which the fluid diffusion resistance is larger than that of the first passage 310b is disposed, the fuel sometimes remains in the first passage 310b in the case where the power generation is stopped.

For example, in the case of using methanol fuel as the fuel, if the fuel remaining in the fuel cell 100f is left unremoved after the stop of the power generation, then the methanol moves to the cathode catalyst layer 2 side owing to diffusion (a type of so-called methanol crossover), and the methanol is reacted with oxygen in the cathode catalyst layer 2, and is then consumed. As described above, the methanol in the first passage 310b is successively consumed selectively owing to the diffusion, whereby the concentration of the methanol in the first passage 310b is decreased.

Even if the power generation is resumed in a state where the fuel in which the concentration of the methanol is decreased is left in the first passage 310b, a diffusion rate of the methanol in the liquid becomes low, and accordingly, sufficient power generation cannot be sometimes performed from the beginning.

In order to increase such a methanol concentration, it is considered to feed high-concentration fuel to the first passage 310b. However, the cathode catalyst layer 1 and the anode catalyst layer 2 may be damaged, if such high-concentration fuel is in contact with the anode catalyst layer 1 and the cathode catalyst layer 2 of the MEA 8. Accordingly, a performance of the MEA 8 may be deteriorated.

In accordance with the fuel cell 100f shown in FIG. 12, in the case where the power generation is stopped, the fuel in the first passage 310b is drained by the pump 84 through the branch passage 33, and is stored in the tank 39. In such a way, the liquid goes away from the fuel passage 301b and the through holes 10a. In the case of resuming the power generation, such low-concentration fuel housed in the tank 39 is supplied into the first passage 301b and the through holes 10a by the pump 84. In such a way, the power generation can be resumed quickly. Moreover, the possibility that the high-concentration fuel may be brought into contact with the MEA 8 can also be reduced, thus making it possible to suppress the performance decrease of the MEA 8.

In FIG. 12, the pump 85 that serves for both of the fuel feeding from the fuel container 50 and the fuel collection to the tank 39 is adopted for the purpose of miniaturization. However, it is a matter of course that a pump for feeding the fuel and a pump for collecting the fuel may be provided separately. Moreover, there also may be provided such a passage that directly collects the fuel in the first passage 310 from the second passage 311b.

### (Sixth Modification)

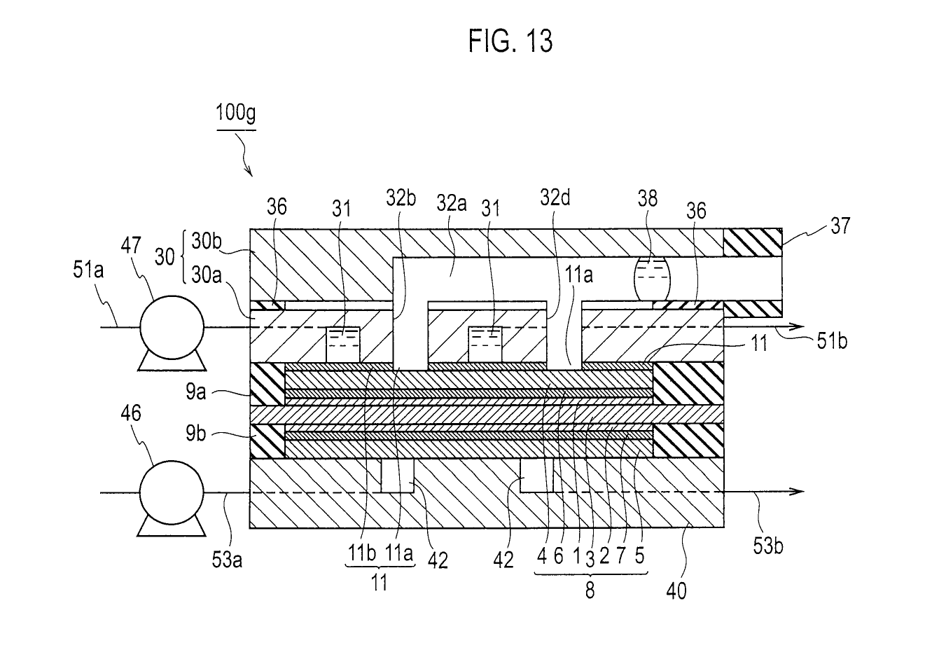

As shown in FIG. 13, a fuel cell 100g (fuel cell system) according to a sixth modification of the first embodiment includes a hydrophilic porous body 11 disposed between the anode passage plate 30 and the anode gas diffusion layer 4.

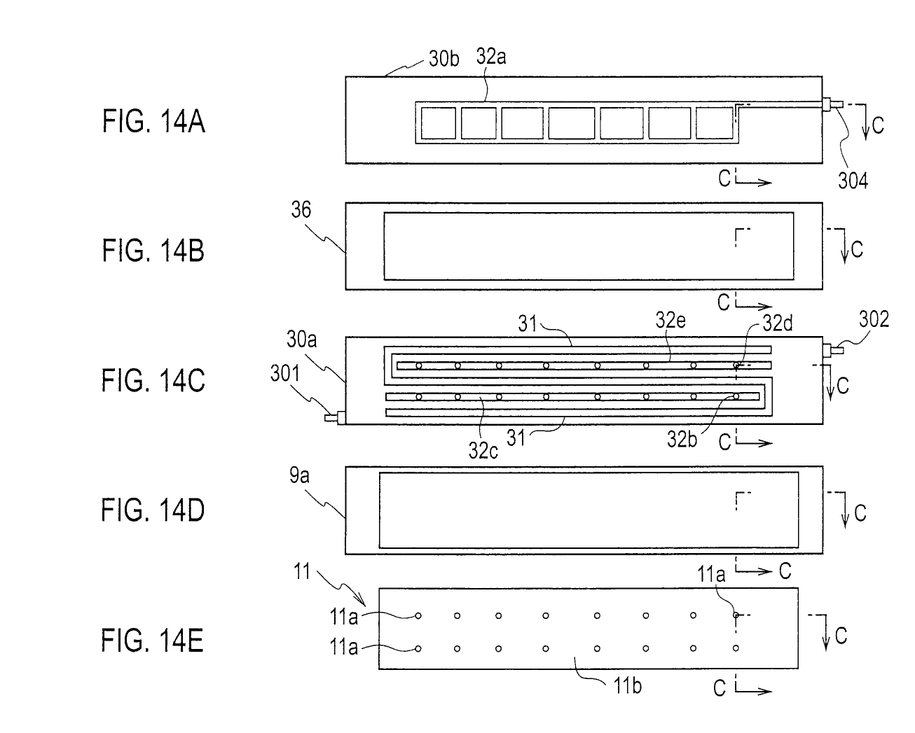

The hydrophilic porous body 11 has a plurality of through holes 11a which penetrate a surface thereof in contact with the anode gas diffusion layer 4 and a surface thereof in contact with the anode passage plate 30. As shown in FIG. 14E, the through holes 11a are opened in a grid pattern on the surface of a sheet-like hydrophilic carbon porous body having micropores with a thickness of approximately 200 μm and a pore diameter of several microns. A pore diameter of the through holes 11a is made sufficiently larger than the several microns which are the pore diameter of the hydrophilic porous body 11. For example, the pore diameter of the through holes 11a can be set at approximately 1 mm. Moreover, the pore diameter of the through holes 11a is appropriately changeable in response to the width and the like of the passage of the anode passage plate 30.

As the hydrophilic porous body 11, carbon paper, carbon cloth or the like, which has micropores with a pore diameter of several microns and is made of carbon fiber subjected to the hydrophilic treatment, is used. Alternatively, it is possible to use hydrophilic sintered metal that has micropores with a pore diameter of several microns, and a hydrophilic porous material that has micropores with a pore diameter of several microns or less and has the electric conductivity.

End portions of the gas passages 32b and 32d of the anode passage plate 30 shown in FIG. 13 are connected to the through holes 11a of the hydrophilic porous body 11. The fuel passage 31 is connected to a portion (region 11b of FIG. 14E) of the hydrophilic porous body 11, in which the through holes 11a are not formed. Other configurations are substantially similar to those of the fuel cell 100a shown in FIG. 1, and accordingly, a duplicate description thereof is omitted.

In accordance with the fuel cell 100g shown in FIG. 13, since the hydrophilic porous body 11 is hydrophilic, the fuel fed to the fuel passage 31 by the liquid feed pump 60 and the like is held in the hydrophilic porous body 11. Meanwhile, with regard to CO₂ that is generated by the anode reaction and is conveyed to the anode gas diffusion layer 4, at the time when CO₂ concerned reaches an interface between the anode gas diffusion layer 4 and the hydrophilic porous body 11, it is easier for CO₂ concerned to pass through the through holes 11a than to pass through the hydrophilic porous body 11 that holds the liquid (fuel). Accordingly, CO₂ is housed in the through holes 11a while giving a higher priority thereto.

Then, CO₂ that passes through the through holes 11a of the hydrophilic porous body 11 is collected by using the gas passages 32a to 32e, whereby CO₂ can be suppressed from being mixed into the fuel passage 31 side. By disposing the hydrophilic porous body 11, CO₂ can be discharged in a state of being subjected to the gas-liquid separation even if the MEA 8 is inclined in an arbitrary direction. The configurations of the fuel cells 10a to 100f, which are described in the first to fifth modifications, can be applied to the fuel cell 100g described in the sixth embodiment; however, illustration of the configurations is omitted here.

### SECOND EMBODIMENT

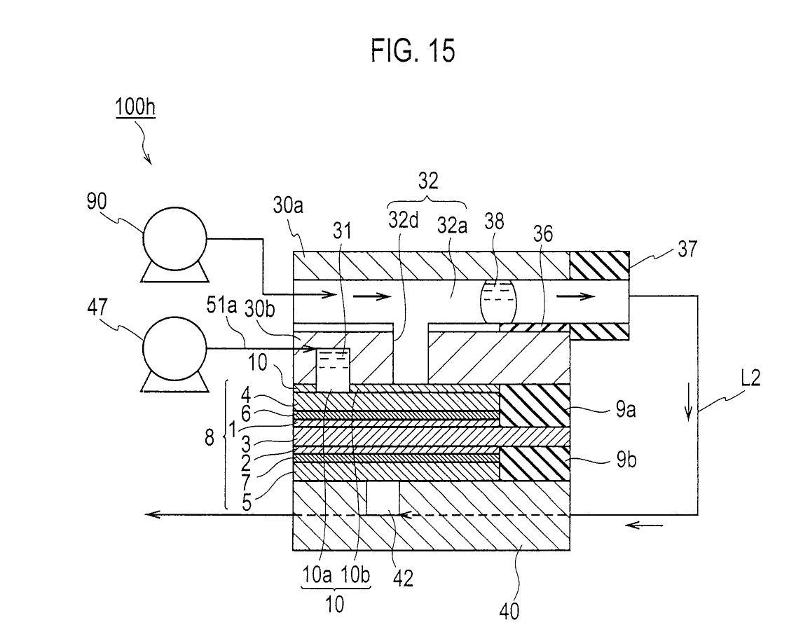

As shown in FIG. 15, a fuel cell 100h according to a second embodiment includes: the MEA 8; the hydrophobic porous body 10 in contact with the MEA 8; the anode passage plate 30 including, on the surface thereof in contact with the hydrophobic porous body 10, the gas passage 32 that collects the gas, which is generated in the anode electrode, through the hydrophobic porous body 10, and the fuel passage 31 that feeds the fuel to the MEA 8; and gas supply unit 90 for supplying the gas to the gas passage 32a.

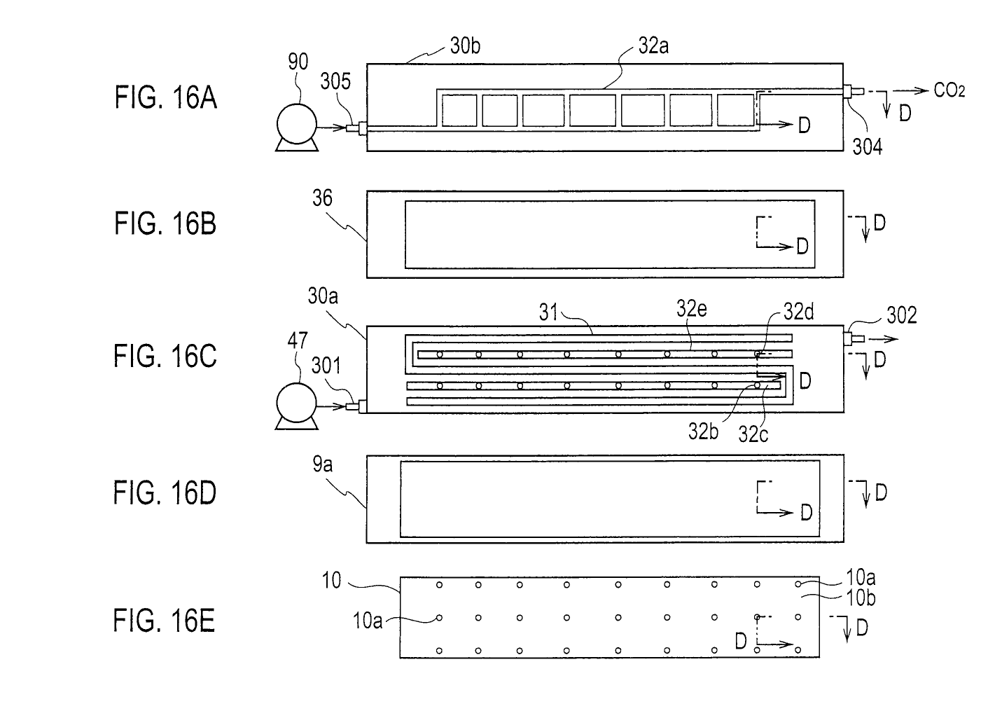

As shown in FIGS. 16A to 16C, the gas passage 32 includes: the gas passages 32c and 32e, which are in contact with the hydrophobic porous body 10 and are formed into a groove shape on the surface of the first anode passage plate 30a; the gas passages 32b and 32d, which are formed into such grooves of the gas passages 32c and 32e and penetrate the first anode passage plate 30a; and the gas passage 32a that is formed into a groove shape on the surface of the second anode passage plate 30b and is connected to the gas passages 32b and 32d.

As shown in FIG. 16A, the gas passage 32a has an inlet end 305 and an outlet end 304. The gas supply unit 90 is connected to the inlet end 305, and supplies a second gas from the inlet end 305 to the outlet end 304. As the gas supply unit 90, for example, a pump and the like are suitably used. The “second gas” may include an external gas such as air, a gas which includes an oxidizing agent such as oxygen, and the like. Other gas such as nitrogen may be also used as the second gas.

The outlet end 304 of the gas passage 32a is connected to an air supply line (air supply pipe) L2 connected to the air introduction passage 42 through a manifold and the like. The air is introduced into the air introduction passage 42 through the line L2, whereby it is unnecessary to separately provide a pump for supplying the air to the air introduction passage 42. Therefore, the fuel cell 100h can be miniaturized. Other configurations are substantially similar to those of the fuel cell 100a shown in FIG. 1, and accordingly, a description thereof is omitted.

At the time of the power generation, CO₂ generated by the anode reaction passes through the gas passage 32a, and is discharged to the outside of the fuel cell 100h. However, when the power generation is stopped, the generation of CO₂ is stopped. Accordingly, the inner pressure of the gas passage 32a is radically decreased. As a result, the gas flows in the direction from the outlets of the gas passages to the hydrophobic porous body 10. This direction is reverse to the flowing direction of the gas at the time of the power generation.

As a result, following the flow of the gas, the liquid droplets 38 attached onto the gas passages 32a to 32e and the outlet end 304 thereof flow in the direction of the hydrophobic porous body 10, then reach the hydrophobic porous body 10, and thereby sometimes wet the hydrophobic porous body 10. Meanwhile, even if the liquid droplets do not move, the inner pressures of the gas passages 32a to 32e and the anode electrode (anode catalyst layer 1, anode gas diffusion layer 4 and anode microporous layer 6) are decreased to an extent where the fuel in the fuel passage 31 overcomes the hydrophobicity of the hydrophobic porous body 10 and is absorbed thereto. This causes the hydrophobic porous body 10 to be wet by the liquid.

In the second embodiment, the second gas is flown in advance in the gas passage 32a by the gas supply unit 90, whereby the inside of the gas passage 32a is dried, and the occurrence of the liquid droplets 38 can be suppressed. Moreover, the gas is always supplied into the gas passage 32a by the gas supply unit 90 at the time of the power generation, whereby the concentration of CO₂ in the gas passage 32a can be reduced. As a result, at the time when the power generation is stopped, the reverse flow of CO₂ in the gas passage 32a can be suppressed more effectively. Furthermore, even in the case where the liquid droplets 38 occur, the liquid droplets 38 can be flown to the downstream side, and accordingly, an apprehension that the hydrophobic porous body 10 may be wet by the reverse flow of the liquid droplets 38 is reduced.

Note that it is preferable to selectively flow the second gas to the gas passage 32a having a passage direction in substantially parallel to the electrode surface of the MEA 8. For example, as the gas passage 32d in contact with the hydrophobic porous body 10, a passage is adopted, in which the fluid diffusion resistance is larger (the pressure loss is larger) than that of the gas passage 32a. In such a way, the second gas can be suppressed from being mixed into the gas passage 32d, and the MEA can be suppressed from being dried excessively by the fact that the second gas flows therethrough. In order to increase the fluid diffusion resistance of the gas passage 32d more than that of the gas passage 32a, for example, as the gas passage 32d, a pipe thinner in diameter than the gas passage 32a just needs to be disposed. Alternatively, a plate having micropores just needs to be disposed in the gas passage 32d, or so on.

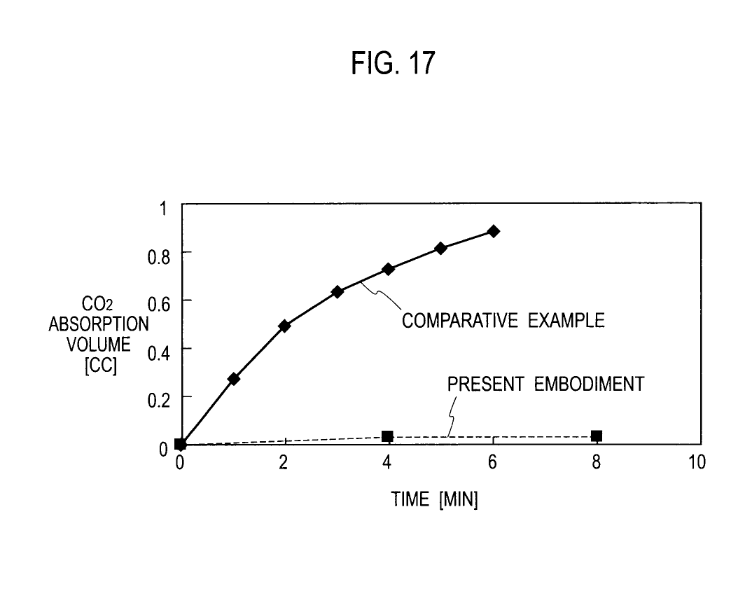

FIG. 17 is a graph showing comparison in CO₂ absorption amount (volume) of the hydrophobic porous body 10 between the case where the second gas is supplied to the gas passage 32a through the gas supply unit 90 and the power generation is stopped and the case where the second gas is not supplied into the gas passage 32a and the power generation is stopped. From this graph, it is understood that the CO₂ absorption amount can be considerably decreased by supplying the second gas to the gas passage 32a.

The second embodiment has been described by taking as an example the gas-liquid separation method using the hydrophobic porous body 10; however, the second embodiment is not limited to this. Specifically, it is a matter of course that, also in the second embodiment, a similar mode to those of the fuel cells shown in FIGS. 1 to 14 can be adopted by appropriately combining the configurations for use in the fuel cells 100a to 100g described with reference to FIGS. 1 to 14 and the configuration of FIGS. 15 and 16A to 16E with each other.

For example, unlike the first embodiment, in the second embodiment, even if the material having the lower CO₂ permeability than the first seal portion 9b is not used as the second seal portion 9a, the soakage of the liquid droplets 38 to the hydrophobic porous body 10 or the hydrophilic porous body 11 and the reverse flow of the discharge gas can be suppressed. However, it is a matter of course that, in order to enhance the gas-liquid separation capability, the material having the lower CO₂ permeability than the first seal portion 9b of the fuel cell 100h may be used as the second seal portion 9a thereof.

With regard to timing when the gas supply unit 90 feeds the air to the gas passage 32a, it is considered to feed the air at least before and after the stop of the power generation from a viewpoint of preventing the reverse flow of CO₂ and the liquid droplets 38 owing to the radical pressure change on the anode electrode side. However, the gas may be always fed to the gas passage 32a. With regard to a feeding control of the gas, an operator may perform a manual operation therefor. Alternatively, in response to a situation where the fuel cell 100h generates the power, the feeding of the gas may be automatically controlled by a control device (not shown) connected to the fuel cell 100h.

Various modifications will become possible for those skilled in the art after receiving the teachings of the present disclosure without departing from the scope thereof.

What is claimed is:

1. A fuel cell system comprising:
a membrane electrode assembly including an anode electrode, a cathode electrode, and an electrolyte membrane interposed between the anode electrode and the cathode electrode;
a porous body in contact with the anode electrode;
an anode passage plate in contact with the porous body, comprising a gas passage collecting a gas generated in the anode electrode and a fuel passage supplying a fuel to the anode electrode;
a first seal portion sealing outer circumferences of the cathode electrode;
a second seal portion sealing outer circumferences of the anode electrode; and
a third seal portion sealing the gas passage,
wherein the second seal portion and the third seal portion comprise a material comprising lower CO₂ gas permeability than that of the first seal portion.

2. The system of claim 1, wherein the second seal portion comprises one of ethylene propylene diene terpolymer, polyphenylene sulfide resin and polyether ether ketone resin.

3. The system of claim 1, wherein the third seal portion comprises one of ethylene propylene diene terpolymer, polyphenylene sulfide resin and polyether ether ketone resin.

4. The system of claim 1, wherein the second seal portion and the third seal portion are coated with a material comprising CO₂ gas permeability lower than that of the first seal material.

5. The system of claim 1, wherein the porous body comprises a hydrophobic porous body comprising a through hole in contact with the fuel passage.

6. The system of claim 1, wherein the porous body comprises a hydrophilic porous body comprising a through hole in contact with the gas passage.

7. The system of claim 5, further comprising a hydrophilic porous body embedded in the through hole of the hydrophobic porous body.

8. The system of claim 6, further comprising a hydrophobic porous body embedded in the through hole of the hydrophilic porous body.

9. The system of claim 1, further comprising a contact which penetrates both surfaces of the porous body and embedded in the porous body.

10. The system of claim 1, wherein the fuel passage further comprises:
a first passage in contact with the porous body; and
a second passage connected to the first passage,
wherein the second passage has greater fluid diffusion resistance than the first passage.

11. The system of claim 10, further comprising:
a branch passage connected to the first passage;
a tank connected to the branch passage and configured to contain the fuel in the first passage; and
a pump configured to supply the fuel in the first passage to the tank or to supply the fuel in the tank to the first passage.

12. The system of claim 1, further comprising:
a gas supply unit configured to supply a second gas to the gas passage.

13. A fuel cell system comprising:
a fuel container containing a fuel;
a fuel cell connected to the fuel container, comprising:
a membrane electrode assembly comprising an anode electrode, a cathode electrode, and an electrolyte membrane interposed between the anode electrode and the cathode electrode;
a porous body in contact with the anode electrode;
an anode passage plate in contact with the porous body, comprising a gas passage collecting a gas generated in the anode electrode and a fuel passage supplying the fuel to the anode electrode;
a first seal portion sealing outer circumferences of the cathode electrode;
a second seal portion sealing outer circumferences of the anode electrode; and
a third seal portion sealing the gas passage,
wherein the second seal portion and the third seal portion comprise a material comprising lower CO₂ gas permeability than that of the first seal portion; and
a circulation line connected to the fuel passage, configured to circulate the fuel discharged from an outlet of the fuel passage to the fuel passage.

14. The system of claim 13, wherein the second seal portion comprises one of ethylene propylene diene terpolymer, polyphenylene sulfide resin and polyether ether ketone resin.

15. The system of claim 13, wherein the third seal portion comprises one of ethylene propylene diene terpolymer, polyphenylene sulfide resin and polyether ether ketone resin.

16. The system of claim 13, wherein the second seal portion and the third seal portion are coated with a material comprising CO₂ gas permeability lower than that of the first seal portion.

17. The system of claim 13, wherein the porous body includes a hydrophobic porous body comprising a through hole in contact with the fuel passage.

18. The system of claim 13, wherein the porous body comprises a hydrophilic porous body having a through hole in contact with the gas passage.

19. The fuel cell system of claim 17, further comprising a hydrophilic porous body embedded in the through hole of the hydrophobic porous body.

20. The fuel cell system of claim 18, further comprising a hydrophobic porous body embedded in the through hole of the hydrophilic porous body.
